(19) United States
(12) Patent Application Publication
(10) Pub. No.: US 2015/0207833 A1
(43) Pub. Date: Jul. 23, 2015

(54) OBJECT DISPLAY SYSTEM, RECORDING MEDIUM RECORDING OBJECT DISPLAY CONTROL PROGRAM, AND, OBJECT DISPLAY CONTROL METHOD

(71) Applicant: KONICA MINOLTA, INC., Tokyo (JP)

(72) Inventors: Ikuko TSUBOTANI, Tokyo (JP); Shinya OGINO, Tokyo (JP); Shunsuke TAKAMURA, Tokyo (JP); Kazuma TAKEUCHI, Tokyo (JP)

(73) Assignee: KONICA MINOLTA, INC., Tokyo (JP)

(21) Appl. No.: 14/588,621

(22) Filed: Jan. 2, 2015

(30) Foreign Application Priority Data
Jan. 21, 2014 (JP) 2014-008388

(51) Int. Cl. H04L 29/06; G06F 3/0484

(52) U.S. Cl. CPC H04L 65/403; G06F 3/04842

(57) ABSTRACT

An object display system includes: a display unit configured to display an object on a display screen; an operation unit enabling the object to be operated; and a control unit which controls the display unit and the operation unit, wherein, when a new object is added, the control unit determines whether a display state of a plurality of objects satisfies a predetermined removing condition on the basis of a size of area of the plurality of objects displayed on the display screen, and when the display state of the plurality of objects satisfies the removing condition, the control unit controls the display unit so as to remove at least one particular object selected from among the plurality of objects from at least a portion of the display position of the particular object.

The entire disclosure of Japanese Patent Application No. 2014-008388 filed on Jan. 21, 2014 including description, claims, drawings, and abstract are incorporated herein by reference in its entirety.

### BACKGROUND OF THE INVENTION

1. Field of the Invention

The present invention relates to an object display system, a recording medium recording an object display control program, and an object display control method, and more particularly, relates to an object display system capable of displaying and operating an object, an object display control program for controlling display of an object, and an object display control method.

2. Description of the Related Art

In recent years, a display screen usable by multiple users (which will be referred to as a shared screen) is used to write and draw display elements (hereinafter referred to as objects) such as characters, figures, and images on the shared screen to have an electronic conference and the like to have a discussion. With such shared screen, multiple users have a discussion while writing various kinds of objects and moving a written object to any given location in the shared screen.

In the conventional system using the shared screen explained above, new objects can be added without limitation, and therefore, when the size of area of the display screen for objects increases (which means the margin area decreases), then the balance of display of objects with respect to the entire screen is lost, which makes it not easy for the user to focus on individual objects, and therefore it is impossible to have an efficient discussion. In the conventional system, when another object is displayed at a position to which a new object is to be added, the objects overlap each other, which reduces the visibility of the objects, and in this case, it is also impossible to have efficient discussion. Because of such background, it is desired to suggest a method to efficiently display multiple objects.

Although a publication of Japanese Translation of PCT Application No. 2006-513485 (Pamphlet of International Patent Application Publication No. 2004-63917) is not a technique relating to displaying of objects, but, for example, publication of Japanese Translation of PCT Application No. 2006-513485 (Pamphlet of International Patent Application Publication No. 2004-63917) discloses a method for rearranging a view that does not overlap on a screen of a computer, and the method includes a step of causing the computer to receive a rearranging request from a user, a step of causing the computer to determine an alternative arrangement in response to the rearranging request, and a method of causing the computer to display the alternative arrangement on the screen, and indicates that it is preferable to maintain the original size of the view.

The technique of the publication of Japanese Translation of PCT Application No. 2006-513485 (Pamphlet of International Patent Application Publication No. 2004-63917) is to change the layout of multiple views, and even if the layout of objects is changed by applying this technique to a system for arranging many objects on a screen, the size of area of the display screen for objects is not changed, and therefore, this cannot improve the situation in which it is difficult to focus on individual objects. When many objects are already occupying the screen, it may be impossible to add a new object so as not to overlap other objects even if the layout of the objects is changed.

Even if a space for adding a new object is secured by changing the layout of the objects, the arrangement of many objects is changed to secure the space, and when the arrangement of an object which has an important meaning is changed, this makes it impossible to have an effective discussion.

In order to cope with this problem, the publication of Japanese Translation of PCT Application No. 2006-513485 (Pamphlet of International Patent Application Publication No. 2004-63917) explained above indicates that, when a user gives a fixing instruction to a particular view in a certain arrangement pattern, the view is thereafter fixed at that position, and only the arrangement of the other views is allowed to be changed. However, in the technique of the publication of Japanese Translation of PCT Application No. 2006-513485 (Pamphlet of International Patent Application Publication No. 2004-63917) explained above, the fixing of the view cannot be easily cancelled, and therefore, when there are many fixed views, the change of the layout is restricted, and as a result, the user has to do rearrangement work of the view on every occasion. Therefore, even if the technique of the publication of Japanese Translation of PCT Application No. 2006-513485 (Pamphlet of International Patent Application Publication No. 2004-63917) explained above is applied to the system for arranging many objects on the screen, it is impossible to appropriately change the layout of objects.

JP 6-282400 A indicates that, when a picture displayed on the screen and a pop-up menu are displayed in contact with each other on the display screen of a personal computer, the pop-up unit is moved to a vacant area, and if there is no vacant area, then the pop-up menu is erased. However, in JP 6-282400 A explained above, when there is not a sufficient area for displaying a pop-up menu, the pop-up menu disappears, and therefore, there is a problem in that the user is unable to sufficiently understand the contents of the pop-up menu.

### SUMMARY OF THE INVENTION

The present invention has been made in view of the above problems, and it is a main object of the present invention to provide an object display system and object display control program and an object display control method capable of appropriately adding a new object when multiple objects are arranged on a screen.

It is another object of the present invention is to provide an object display system and object display control program and an object display control method capable of appropriately changing the layout of objects when multiple objects are arranged on a screen.

To achieve at least one of the abovementioned objects, according to an aspect, an object display system reflecting one aspect of the present invention comprises: a display unit configured to display an object on a display screen; an operation unit enabling the object to be operated; and a control unit which controls the display unit and the operation unit, wherein, when a new object is added, the control unit determines whether a display state of a plurality of objects satisfies a predetermined removing condition on the basis of a size of area of the plurality of objects displayed on the display screen, and when the display state of the plurality of objects satisfies the removing condition, the control unit controls the display unit so as to remove at least one particular object selected from among the plurality of objects from at least a portion of the display position of the particular object.

To achieve at least one of the abovementioned objects, according to an aspect, a non-transitory recording medium recording a computer readable object display control program operating with a control unit which controls a display unit configured to display an object on a display screen and an operation unit enabling the object to be operated, reflecting one aspect of the present invention, causes the control unit to execute: first processing in which, when a new object is added, a determination is made as to whether a display state of a plurality of objects satisfies a predetermined removing condition defined on the basis of a size of area of the plurality of objects displayed on the display screen; and second processing in which, when the display state of the plurality of objects satisfies the removing condition, at least one particular object selected from among the plurality of objects is removed from at least a portion of the display position of the particular object.

To achieve at least one of the abovementioned objects, according to an aspect, an object display control method for a system including a display unit configured to display an object on a display screen, an operation unit enabling the object to be operated, and a control unit which controls the display unit and the operation unit, reflecting one aspect of the present invention, causes the control unit to execute: first processing in which, when a new object is added, a determination is made as to whether a display state of a plurality of objects satisfies a predetermined removing condition on the basis of a size of area of the plurality of objects displayed on the display screen; and second processing in which, when the display state of the plurality of objects satisfies the removing condition, at least one particular object selected from among the plurality of objects is removed from at least a portion of the display position of the particular object.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a figure schematically illustrating an external appearance of an object display system according to a first embodiment of the present invention;

FIG. 2 is a figure schematically illustrating another external appearance of an object display system according to the first embodiment of the present invention;

FIGS. 3A and 3B are block diagrams illustrating a configuration of a display apparatus according to the first embodiment of the present invention;

FIG. 4 is a block diagram illustrating a configuration of a computer terminal according to the first embodiment of the present invention;

FIG. 5 is a flowchart diagram illustrating processing of the computer terminal according to the first embodiment of the present invention;

FIG. 6 is a flowchart diagram illustrating processing of a display apparatus according to the first embodiment of the present invention;

FIG. 7 is a flowchart diagram illustrating another processing of the display apparatus according to the first embodiment of the present invention;

FIG. 8 is a schematic diagram illustrating an example of display of objects according to the first embodiment of the present invention.

FIGS. 9A to 9C are schematic diagrams illustrating the size of area in which objects can be arranged according to the first embodiment of the present invention;

FIGS. 10A to 10C are schematic diagrams illustrating an example of display control of an object according to the first embodiment of the present invention;

FIGS. 11A and 11B are schematic diagrams illustrating another example of display control of an object according to the first embodiment of the present invention (moving of a new object);

FIG. 12 is a schematic diagram illustrating another example of display control of an object according to the first embodiment of the present invention (saving of an object to be removed);

FIG. 13 is a flowchart diagram illustrating processing of a display apparatus according to a second embodiment of the present invention;

FIGS. 14A to 14C are schematic diagrams illustrating an example of display control of an object according to the second embodiment of the present invention;

FIG. 15 is a flowchart diagram illustrating processing of a display apparatus according to a third embodiment of the present invention (setting processing of a fixed object);

FIG. 16 is a flowchart diagram illustrating processing of a display apparatus according to the third embodiment of the present invention (automatic arrangement processing);

FIGS. 17A to 17C are schematic diagrams illustrating moving, enlarging, reducing of an object according to the third embodiment of the present invention;

FIGS. 18A and 18B are schematic diagrams illustrating an example of display control of an object according to the third embodiment of the present invention (a case where the size of area in which objects can be arranged is large); and

FIGS. 19A to 19C are schematic diagrams illustrating an example of display control of an object according to the third embodiment of the present invention (automatic arrangement in a case where the size of area in which objects can be arranged is small).

### DESCRIPTION OF THE PREFERRED EMBODIMENTS

Hereinafter, an embodiment of the present invention will be described with reference to the drawings. However, the scope of the invention is not limited to the illustrated examples.

As shown in the Description of the Related Art, in a system using a shared screen, various operations are performed on objects, e.g., writing objects and moving objects. In this case, when a new object is added, and if objects are allowed to be added without limitation, the size of area of the display screen for objects becomes larger, and the margin area is reduced, and therefore, the display balance of objects with respect to the entire screen is lost, and there is a problem in that it is difficult to focus on individual objects. When another object is already displayed at a position to which a new object is to be added, the objects would overlap each other, and there is a problem in that this reduces the visibility of the objects.

In order to cope with these problems, the layout of multiple objects can be changed by making use of the technique of publication of Japanese Translation of PCT Application No. 2006-513485 (Pamphlet of International Patent Application Publication No. 2004-63917) explained above, but even if the layout of the objects are changed, the size of area of the display screen for the objects is not changed, and therefore, this could not improve the situation in which it is difficult to focus on individual objects, and when many objects are already occupying the screen, a new object cannot be added so as not to overlap another object in some cases.

Even if a space for adding a new object is secured by changing the layout of the objects, it is impossible to have an effective discussion when the arrangement of an object which has an important meaning is changed. When a particular object is fixed by using the technique of the publication of Japanese Translation of PCT Application No. 2006-513485 (Pamphlet of International Patent Application Publication No. 2004-63917), and it is not easy to set and cancel the fixing, then, the layout is limited when there are many fixed objects, and in this case, multiple objects cannot be arranged in a desired layout.

More specifically, in the publication of Japanese Translation of PCT Application No. 2006-513485 (Pamphlet of International Patent Application Publication No. 2004-63917), all the views are considered to be displayed, and in order to allow a user to easily confirm the details of each of the views, it is desired to display multiple views on the entire screen. On the other hand, objects displayed on a shared screen are of different degrees of importance, and there is a change in the degrees of importance in accordance with the progress in the discussion, and therefore, an object of a low degree of importance may not be necessarily required to be displayed, and in order to allow all of the multiple objects to be seen, it is desired to maintain balance of display of objects with respect to the entire screen.

As described in JP 6-282400 A explained above, when a picture displayed on the screen and a pop-up menu are displayed in contact with each other on the display screen of a personal computer, the pop-up unit is moved to a vacant area, and if there is no vacant area, then the pop-up menu is erased. In this case, when there is no sufficient area for displaying the pop-up menu, then the pop-up menu is erased, and therefore, the user is unable to sufficiently understand the contents of the pop-up menu.

Therefore, according to an embodiment of the present invention, when a new object is added, the size of margin area of the display screen is derived, and when the size of the margin area is less than a predetermined threshold value, an object that is considered to be of a low degree of importance such as an object having an old last-operated time may be erased or the size thereof may be reduced. When an object that is considered to be of a high degree of importance such as an object that is operated within a predetermined time is fixed, and a new object is arranged, then objects other than the fixed object are moved or the sizes thereof are reduced.

Therefore, too many objects are prevented from occupying the screen, and a new object can be appropriately added while maintaining the balance of display. An object which is to be added would not disappear because of the absences of the margin. The layout can be appropriately changed so that an object of a high degree of importance would not be moved when a new object is added. Therefore, when many people are working, this can save the trouble of confirming the usage situation of another user on every occasion.

### First Embodiment

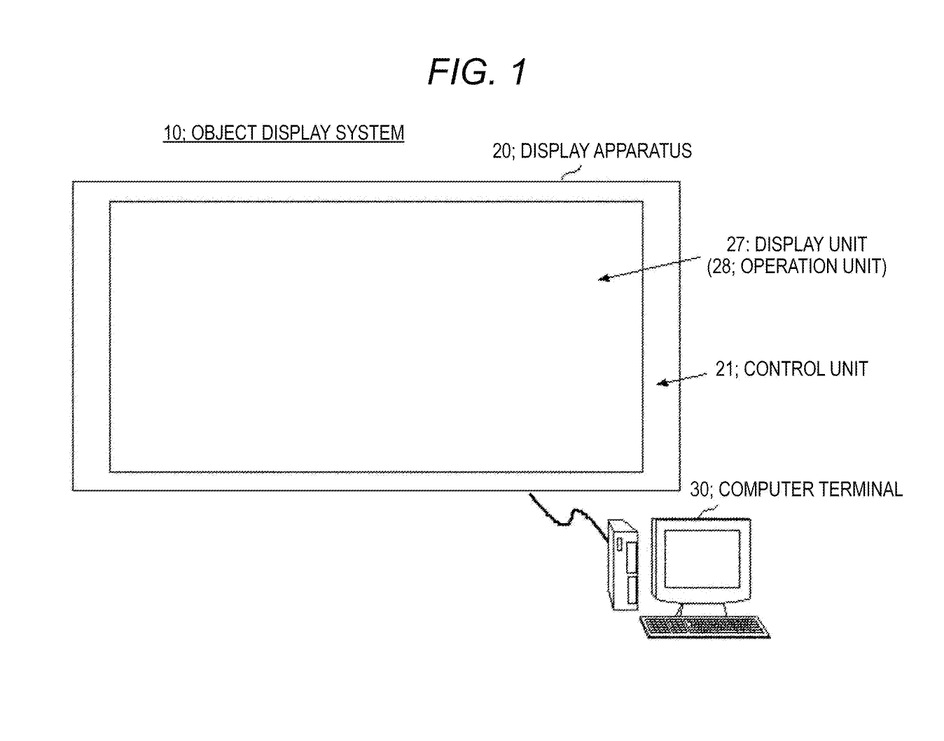

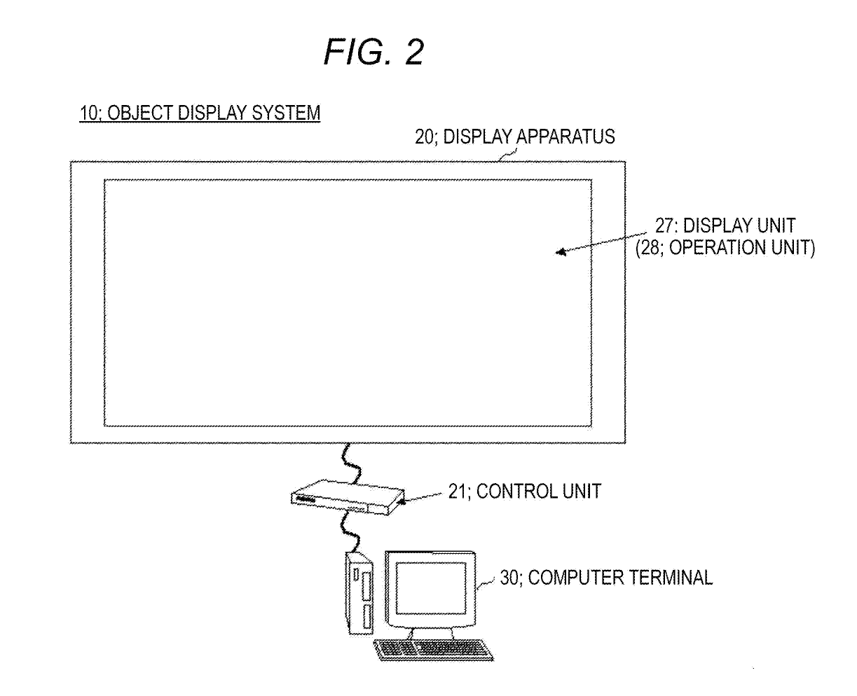

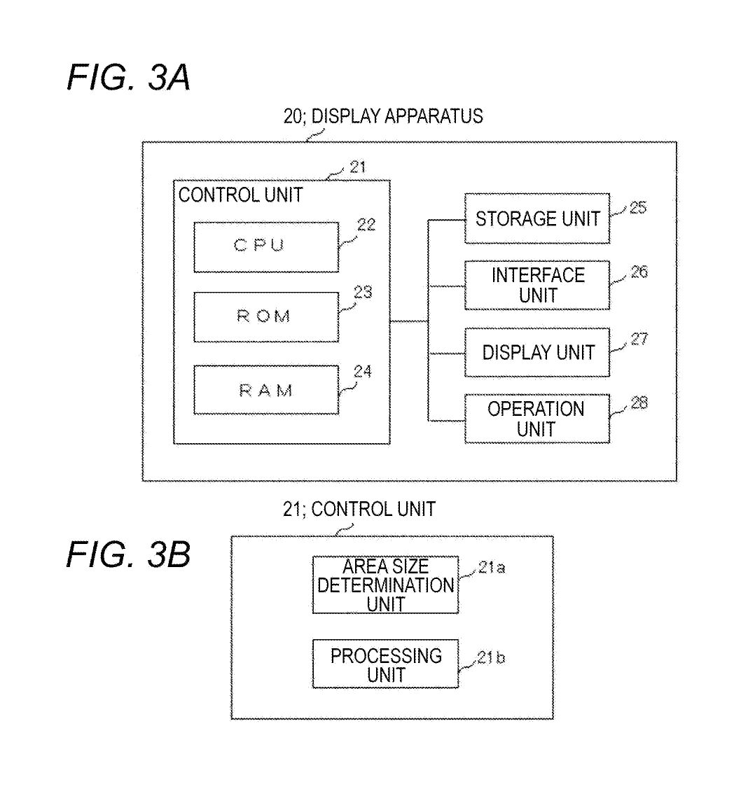

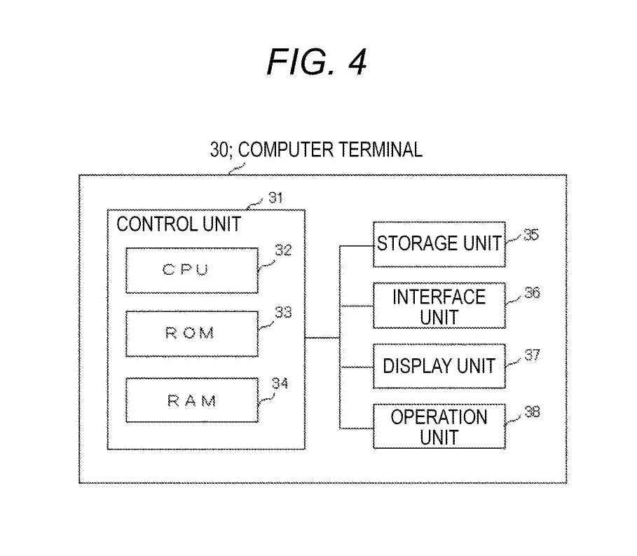

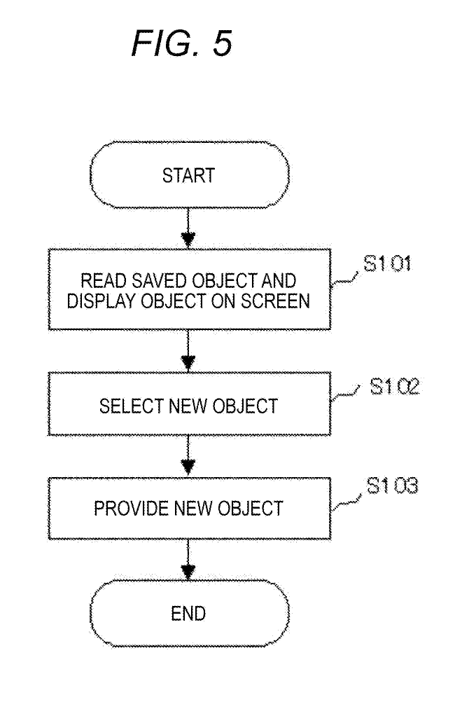

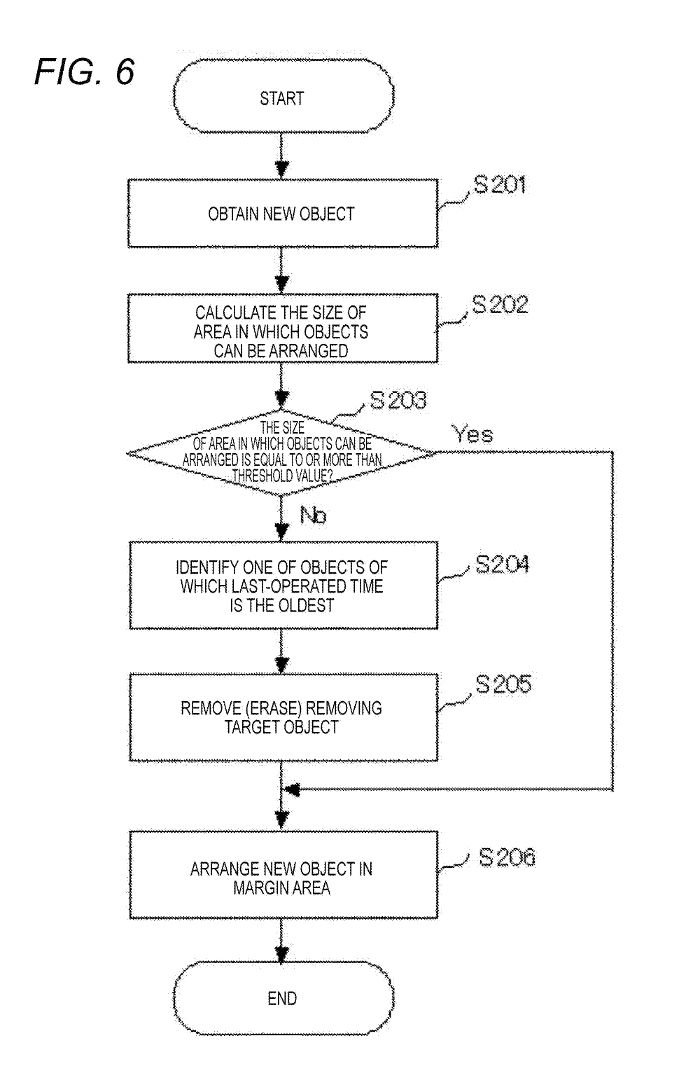

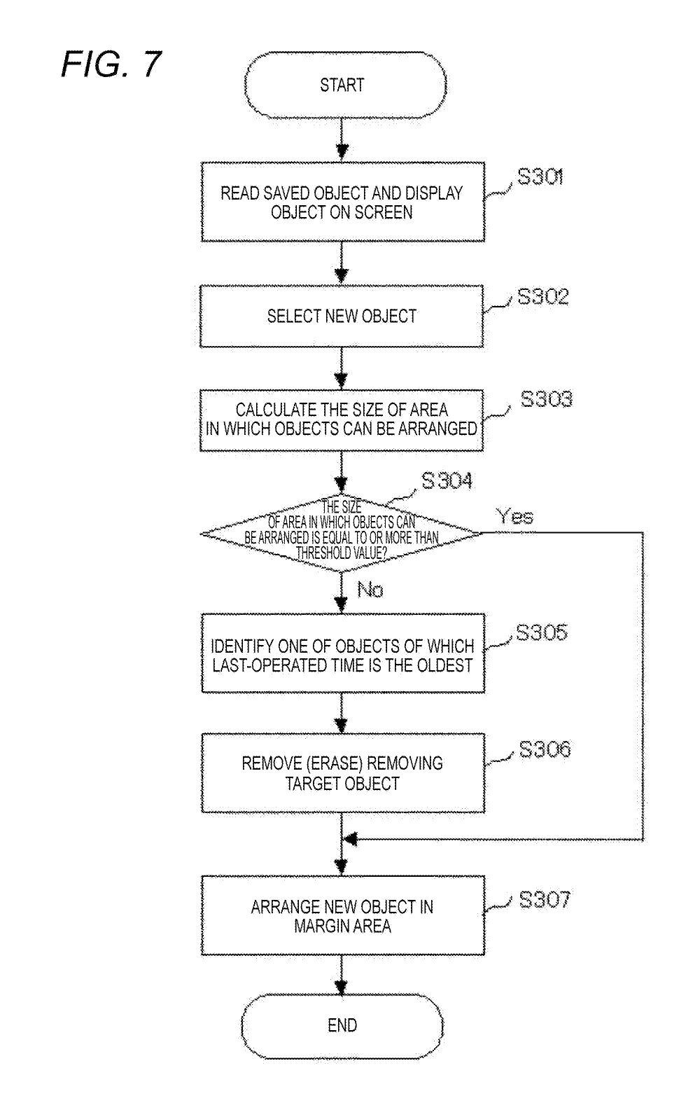

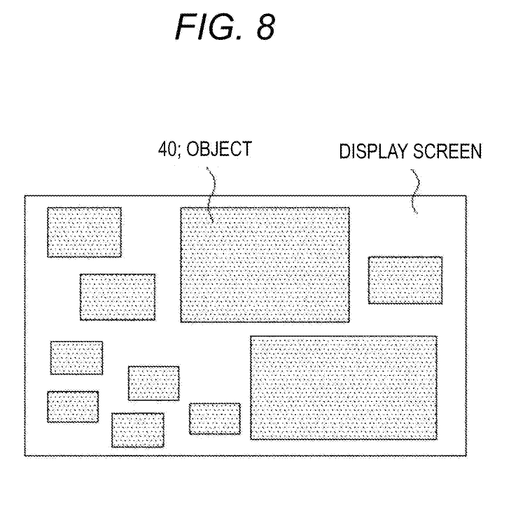

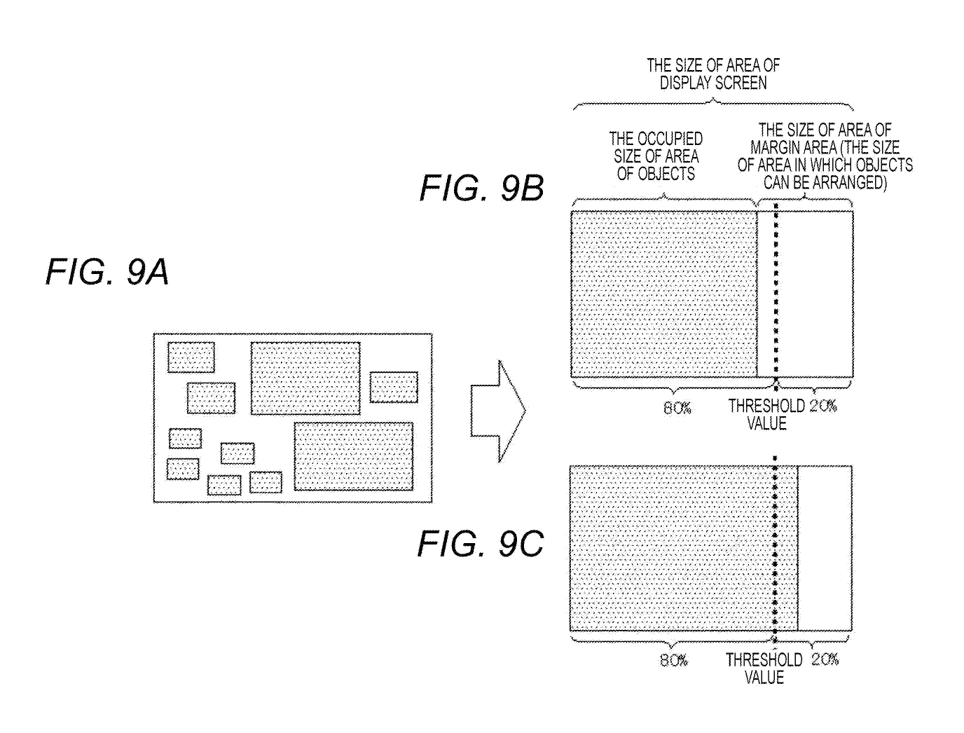

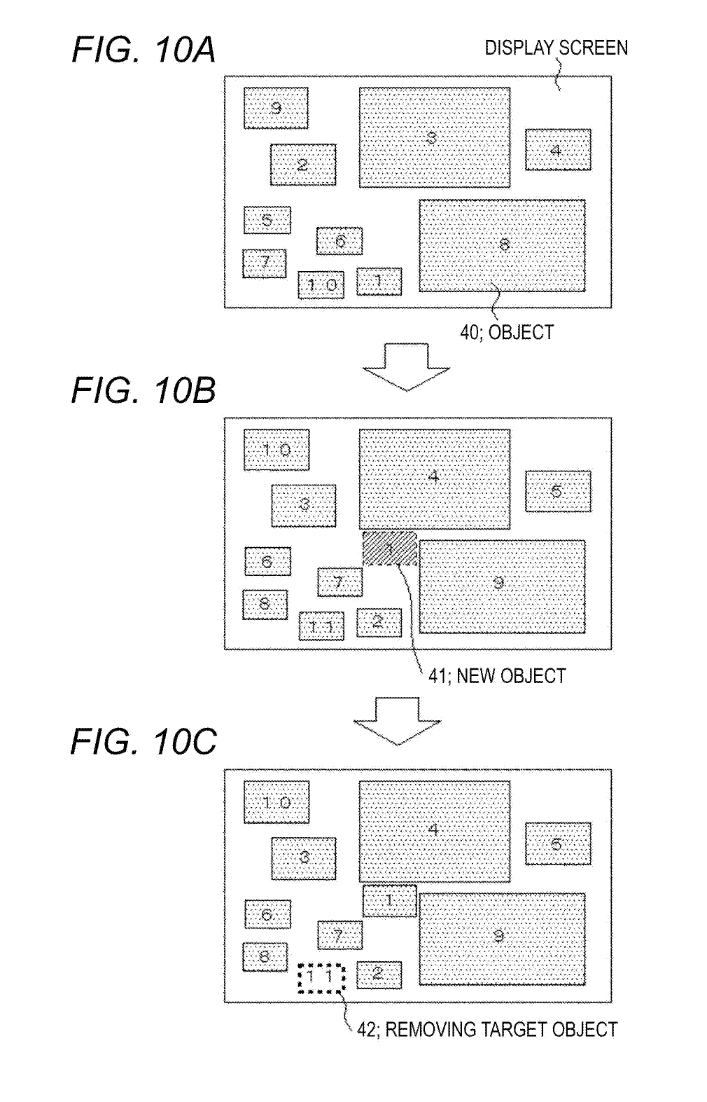

An object display system, an object display control program, and an object display control method according to the first embodiment of the present invention will be explained with reference to FIGS. 1 to 12 in order to further explain in details the embodiments of the present invention explained above. FIGS. 1 and 2 are figures schematically illustrating a configuration of an object display system according to the present embodiment. FIG. 3 is a block diagram illustrating a configuration of a display apparatus. FIG. 4 is a block diagram illustrating a configuration of a computer terminal. FIG. 5 is a flowchart diagram illustrating processing of the computer terminal according to the present embodiment. FIGS. 6 and 7 are flowchart diagrams illustrating processing of a display apparatus according to the present embodiment. FIG. 8 is a schematic diagram illustrating an example of display of objects. FIGS. 9A to 9C are schematic diagrams illustrating the size of area in which objects can be arranged. FIGS. 10A, 10B, and 10C, and FIG. 12 are schematic diagrams illustrating display control of objects according to the present embodiment.

The present invention can be applied to both of the case where there is only one operator and the case where there are multiple operators, but in the present embodiment, a system having a shared work area that can be operated by multiple operators will be explained. This system includes a display apparatus 20 and a computer terminal, and the display apparatus 20 may be configured such that a display unit 27, an operation unit 28, and a control unit 21 are integrally formed as shown in FIG. 1, or a touch panel having a display unit 27 and an operation unit 28 is provided separately from a control unit 21 as shown in FIG. 2. The present embodiment will be hereinafter explained based on the configuration of FIG. 1.

The object display system 10 according to the present embodiment includes a display apparatus 20 which allows for operation and display of texts, graphics, images, and the like (hereinafter referred to as objects), and a computer terminal 30 which generates and transfers objects, and they are connected via a wire or wirelessly. In FIGS. 1 and 2, the object display system 10 includes a computer terminal 30, but when data of objects displayed on the display apparatus 20 are stored to the inside of the display apparatus 20, or data are retrieved via a recording medium such as an SD (Secure Digital) card, then the computer terminal 30 may be omitted. Hereinafter, each apparatus will be explained.

[Display Apparatus]

The display apparatus 20 is a display panel having a calculation function, an electronic blackboard, a portable terminal such as a tablet terminal and a smart phone, a notebook-type computer apparatus, and the like, and includes an control unit 21, an storage unit 25, an interface unit 26, a display unit 27, an operation unit 28, and the like as shown in FIG. 3A.

The control unit 21 includes a CPU (Central Processing Unit) 22, memories such as a ROM (Read Only Memory) 23, and a RAM (Random Access Memory) 24. The CPU 22 calls a control program from the ROM 23 and the storage unit 25, and extracts the control program to the RAM 24 and executes the control program, thus controlling operation of the entire display apparatus 20. As shown in FIG. 3B, the control unit 21 also functions as the area size determination unit 21a and the processing unit 21b.

The area size determination unit 21a refers to object information stored in the storage unit 25, and calculates the size of area of all the objects displayed on the display unit 27 (which will be referred to as the occupied size of area), and calculates the size of area obtained by subtracting the occupied size of area from the size of area of the display screen of the display unit 27 (which will be referred to as the size of area in which objects can be arranged). Then, a determination is made as to whether the size of area in which objects can be arranged thus calculated is equal to or more than a predetermined threshold value (whether or not the margin area is sufficient or not). In calculation of the size of area of the objects, when objects are images, the size of area can be calculated on the basis of the sizes of images, and when objects are texts or graphics, the size of area can be calculated on the basis of the size of the frame encircling the object in question. In the present embodiment, the size of area in which objects can be arranged is compared with a threshold value. Alternatively, the occupied size of area and the threshold value may be compared, or the ratio of the occupied size of area with respect to the size of area of the display screen may be compared with the predetermined threshold value (for example, 80%). In the present embodiment, only the objects which are being displayed are used in the calculation of the occupied size of area. Alternatively, not only the objects which are being displayed but also the objects which are scheduled to be displayed (hereinafter referred to as new objects) may also be used, and if the new objects are taken into the calculation, the size of area in which objects can be arranged can be ensured which is equal to or more than the threshold value even after the new objects have been added.

The processing unit 21b displays objects on the display unit 27 in accordance with a result determined by the area size determination unit 21a. For example, when the size of area in which objects can be arranged is equal to or more than the threshold value, the balance of the display can be maintained even when a new object is added, and therefore, when a position is instructed with the operation unit 28, the new object is arranged at the instructed position (when it overlaps an object which is already displayed, the new object is displayed at such a shifted position that does not overlap the existing object), and when a position is not instructed, the new object is arranged at any given position of the margin area. When the size of area in which objects can be arranged is less than the threshold value, the balance of display is lost when a new object is added, and therefore, a particular object or multiple particular objects are removed from among the objects which are being displayed. More specifically, object information stored in the storage unit 25 (operation history information of objects operated with the operation unit 28) is referred to, and a particular object is set, which is a target to be erased, in the ascending order of the last operation time of the object (in other words, an object having the longest elapsed time since the last operation is chosen first), and the particular object is erased, so that the size of area in which objects can be arranged is equal to or more than the threshold value. When a position is instructed with the operation unit 28, the new object is arranged at the instructed position n (when it overlaps an object which is already displayed, the new object is displayed at such a shifted position that does not overlap the existing object), and when a position is not instructed, the new object is arranged at any given position of the margin area. When the new object is arranged, the new object is arranged with the original size without changing the size thereof. When the particular object is removed, the object may be completely eliminated from the display screen as explained later, or the object may be moved or the size thereof may be reduced so as to partially overlap the display position of the particular object, and the it may be removed from at least a portion of the display position of the particular object.

The area size determination unit 21a and the processing unit 21b may be made as hardware, or may be caused to be executed by causing the CPU 22 provided in the control unit 21 to execute software functioning as the area size determination unit 21a and the processing unit 21b (display control program).

The storage unit 25 is constituted by a flash memory, an HDD (Hard Disk Drive), an SSD (Solid State Drive), and the like, and stores size information about the display screen of the display unit 27, object information (operation history information, size information, layout information, and an object attribute indicating whether an object is a fixed object or a non-fixed object as explained later), the threshold value explained above, and the like. When the CPU 22 is caused to execute the display control program to achieve the functions of the area size determination unit 21a and the processing unit 21b, this display control program is stored to the storage unit 25.

The interface unit 26 is an interface for enabling acquisition of data of objects. For example, when data of objects are retrieved from the computer terminal 30 via a wire or wirelessly, the interface unit 26 would be an NIC (Network Interface Card), a modem, and the like, which establishes connection with the computer terminal 30. When data of objects are retrieved from a recording medium, the interface unit 26 would be an SD card slot, and the like, which enables data communication with a recording medium.

The display unit 27 is constituted by an LCD (Liquid Crystal Display), an organic EL (Electro Luminescence) display, and the like, and displays an object on a display screen according to control of the control unit 21. The operation unit 28 is constituted by a touch sensor made of lattice-like electrodes arranged on the display unit 27, hard keys, and the like, and is configured to receive various kinds of operations performed on objects (for example, operation for selecting, moving, adding, and the like of objects). The display unit 27 and the operation unit 28 constitute a touch panel.

It should be noted that FIG. 3 is an example of a display apparatus 20 according to the present embodiment, and the configuration thereof can be changed as necessary. For example, in the present embodiment, an object is operated on a touch panel. Alternatively, various kinds of operations performed on an object may be achieved using a mouse, keyboard, and the like.

[Computer Terminal]

The computer terminal 30 is a portable terminal and the like such as a personal computer, a tablet terminal, a smart phone, and the like, and as shown in FIG. 4, the computer terminal 30 is constituted by a control unit 31, a storage unit 35, an interface unit 36, a display unit 37, an operation unit 38, and the like.

The control unit 31 includes a CPU 32, memories such as a ROM 33, and a RAM 34. The CPU 32 calls a control program from the ROM 33 and the storage unit 35, and extracts the control program to the RAM 34 and executes the control program, thus controlling operation of the entire computer terminal 30. The control unit 31 also functions as an object generation unit operating various kinds of applications to generate, edit, and obtain an object.

The storage unit 35 is constituted by a memory, an HDD, an SSD, and the like, and is configured to store data of objects generated by the object generation unit and the like.

The interface unit 36 is an interface capable of providing data of objects to the display apparatus 20. For example, when data of objects are transferred via a wire or wirelessly to the display apparatus 20, the interface unit 36 would be an NIC, a modem, and the like, which establishes connection with the display apparatus 20. When data of objects are provided using a recording medium, the interface unit 36 would be an SD card slot, and the like, which enables data communication with a recording medium.

The display unit 37 is constituted by an LCD, an organic EL display, and the like, and is configured to display a screen for generating an object, a screen for allowing the user to select an object displayed on the display apparatus 20, and the like. The operation unit 38 is constituted by a mouse, a keyboard, a touch sensor made of lattice-like electrodes arranged on the display unit 37, hard keys, and the like, and is configured to receive various kinds of operations performed on objects (for example, operation for generating, selecting, transferring and the like of objects).

A display control method of an object using the object display system 10 having the above configuration will be hereinafter explained. First, operation performed by the computer terminal 30 will be explained with reference to the flowchart diagram of FIG. 5.

The user uses the application to generate, edit, and obtain an object, and store the data of the object to the storage unit 35. Then, the control unit 31 reads the data of the object from the storage unit 35, and displays the object on the display unit 37 (S101). When an object to be displayed on the display apparatus 20 (hereinafter referred to as a new object) is selected in a selection screen of an object (S102), the control unit 31 uses the interface unit 36 to provide the data of the new object to the display apparatus 20 (transmit the new object or record the new object to a recording medium) (S103).

Subsequently, operation of the display apparatus 20 will be explained. The CPU 22 extracts a display control program stored in the ROM 23 or the storage unit 25 to the RAM 24 and executes the display control program, thus executing each processing as shown in the flowchart diagram, of FIG. 6. In the explanation, multiple objects are considered to be displayed on the display screen of the display unit 27 in advance.

First, the control unit 21 uses the interface unit 26 to obtain data of the new object from the computer terminal 30 or the recording medium (S201). Alternatively, the control unit 21 obtains the data of the new object by allowing the operator to perform operation with the operation unit 28 or by means of wireless communication via the interface unit 26 that occurs when the operator brings a portable terminal with the display unit 27. Then, the control unit 21 (area size determination unit 21a) refers to object information stored in the storage unit 25 (size information), and calculates the occupied size of area of all the objects displayed on the display unit 27 and calculates the size of area in which objects can be arranged that is obtained by subtracting the occupied size of area of the objects from the size of area of the display screen of the display unit 27 (S202). The control unit 21 determines whether the calculated size of area in which objects can be arranged is equal to or more than a predetermined threshold value (S203). More specifically, in the present embodiment, when a new object is added, the size of area in which objects can be arranged is calculated on the basis of the size of area of the display screen of the multiple objects displayed on the display screen of the display unit 27, and when the size of area in which objects can be arranged is equal to or more than the threshold value, the display state of the multiple objects are determined to satisfy a predetermined condition for removing a particular object (hereinafter referred to as a removing condition), and when the size of area in which objects can be arranged is less than the threshold value, the display state is determined not to satisfy the removing condition.

When the size of area in which objects can be arranged is equal to or more than the threshold value, the new object obtained in S201 can be displayed on the display unit 27, and therefore, the control unit 21 (processing unit 21b) arranges the new object in an area where no object is displayed (margin area), and displays it on the display unit 27 (S206). It should be noted that the new object is arranged without changing the size (without enlarging or reducing the size). The location where the new object is arranged is not limited, and, for example, when the operation unit 28 (a touch panel or a mouse) is used to designate the position, the new object may be arranged at that position (when it overlaps an object which is already displayed, the new object is displayed at such a shifted position that does not overlap the existing object), or when the position is not designated, the new object may be arranged at any given position that does not overlap an object which is already displayed (for example, in a central portion of the largest margin area), or the new object may be arranged in proximity to the same object attribute (text, graphics, and image).

On the other hand, when the size of area in which objects can be arranged is less than the threshold value, the balance of display is lost when the new object is displayed on the display unit 27, and therefore, the control unit 21 (processing unit 21b) refers to the object information (operation history information), and identifies one of objects of which last-operated time is the oldest from among the objects displayed on the display unit 27 (S204), and removes the object (hereinafter referred to as a removing target object) from the display unit 27 (S205). When the removing target object is removed, the removing target object is erased from the screen of the display unit 27 in the present embodiment, but when it is erased from the screen, the data of the object may also be erased from the storage unit 25, or the data of the object may be left in the storage unit 25 (when the data of the object do not exist in the storage unit 25, the data of the object are stored). Thereafter, the control unit 21 (processing unit 21b) arranges the new object in an area where no object is displayed (margin area), and displays it on the display unit 27 (S206).

In the above flow, when the size of area in which objects can be arranged is less than the threshold value, only a single object of which last-operated time is the oldest is removed. Alternatively, when the size of area in which objects can be arranged is made to be equal to or more than the threshold value by just removing a single object, an object of which last-operated time is the second oldest is identified in order and removed until the size of area in which objects can be arranged is equal to or more than the threshold value. Alternatively, all the objects of which last-operated times are older than the predefined time and all the objects of which chronological orders of the last-operated times are lower than a predefined order may be removed at a time, or a particular object therein (for example, an object having the largest size of area) may be removed.

FIGS. 5 and 6 show a flow in a case where a new object selected by the computer terminal 30 is displayed by the display apparatus 20, but a new object may also be selected by the display apparatus 20. In such case, as shown in the flowchart diagram of FIG. 7, the control unit 21 reads the data of the object from the storage unit 25 and causes the display unit 37 to display it (S301), and allows the user to select a new object on the selection screen of the objects (S302). Thereafter, like S202 to S206 in the flowchart diagram of FIG. 6, when the size of area in which objects can be arranged is less than the threshold value, the object of which last-operated time is the oldest is removed from the display unit 27, and when the size of area in which objects can be arranged becomes equal to or more than the threshold value, the new object is displayed in the margin area where no object is displayed (S303 to S307)

The display control explained above will be explained using a specific example. FIG. 8 shows a state in a case where multiple objects 40 are displayed on the display unit 27. In this case, the object 40 is indicated as a rectangular shape, but the size and the shape of an object may be any size and shape. In the present embodiment, objects 40 are arranged so as not to overlap each other, but the objects 40 other than the new object may overlap each other. In this case, the size of area occupied by the objects 40 may be calculated by subtracting the size of area where the objects overlap each other from the summation of the size of area of the objects.

FIGS. 9A to 9C are figures for explaining the size of area in which objects can be arranged. FIG. 9A is an actual display screen, and FIGS. 9B and 9C show the occupied size of area in a case where all the objects are combined. As shown in FIG. 9B, the size of area in which objects can be arranged that is obtained by subtracting the occupied size of area of the objects from the size of area of the display screen of the display unit 27 is equal to or more than a predetermined value (in this case, the ratio of the size of area in which objects can be arranged with respect to the size of area of the display screen is 20%), then the margin area for arranging the new object is determined to be sufficient. On the other hand, as shown in FIG. 9C, the size of area in which objects can be arranged that is obtained by subtracting the occupied size of area of the objects from the size of area of the display screen is less than the predetermined value, the margin area is determined to be insufficient.

FIGS. 10A to 10C illustrate changes in the screen state in a case where a new object is added. As shown in FIG. 10A, ten objects 40 are disposed on the display screen. A number attached to each object represents the order of operation of an object. A larger number indicates an object of which last-operated time is old. The size of area in which objects can be arranged that is obtained by subtracting the occupied size of area of ten objects 40 from the size of area of the display screen is less than a predetermined value.

In the arrangement state of such objects 40, when a new object (object indicated by hatching of diagonal lines) is added as shown in FIG. 10B, the last-operated time of the new object 41 is the latest, and therefore, the number thereof becomes “1”, and one is added to the numbers of the other objects 40, so that the numbers of the other objects 40 are updated to “2” to “11”.

In this case, the size of area in which objects can be arranged is less than the predetermined value, and the margin area is insufficient, and therefore, it is impossible to add the new object 41. Therefore, as shown in FIG. 10C, the object of which last-operated time is the oldest (object of which number is “11”) among the objects 40 which are being displayed is identified as a removing target object 42, and the removing target object 42 is removed from the display screen to increase the margin area, and thereafter the new object 41 is displayed.

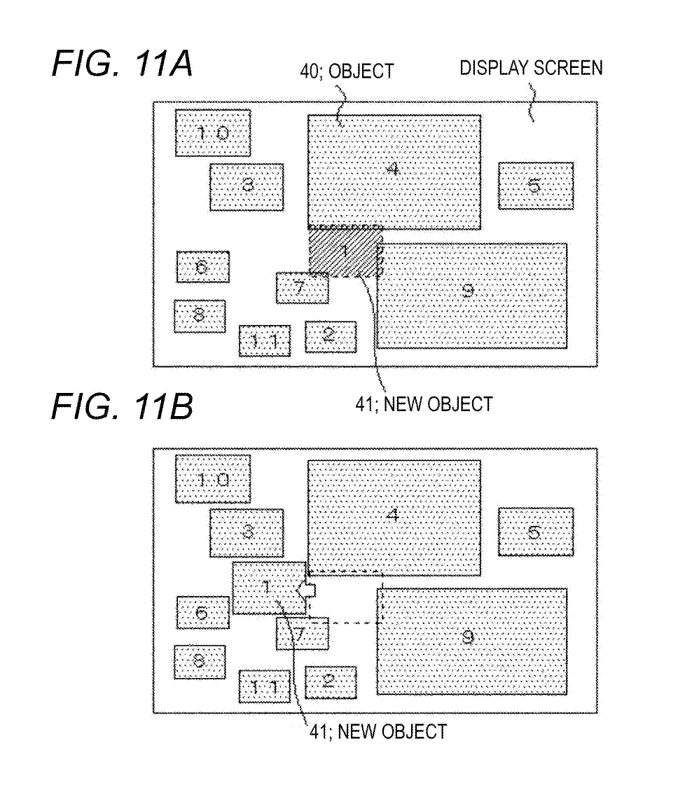

At that occasion, as shown in FIG. 11A, when the new object 41 overlaps the other objects 40 which are being displayed, the display position of the new object 41 is moved without changing the size of the new object 41 (without reducing the size of the new object 41), so that the new object 41 does not overlap the other objects 40 which are being displayed as shown in FIG. 11B. Therefore, the control unit 21 detects, in advance, the shape and the size of the new object 41, and detects, in advance, the position, the shape, and the size of the margin area. As shown in FIG. 12, when the erasing target object 42 is erased from the display screen, data of the erasing target object 42 are saved to a predetermined folder of the storage unit 25, and when the size of area in which objects can be arranged becomes equal to or more than the predetermined value, the erasing target object 42 may be displayed again on the display screen.

As described above, in the present embodiment, when the size of area in which objects can be arranged that is obtained by subtracting the occupied size of area of the objects from the size of area of the display screen is less than the predetermined value when a new object is added, the object of which last-operated time is the oldest (removing target object) is erased from the display screen. At this occasion, the layout and the sizes of objects other than the particular target of the removing target are maintained as they are. Therefore, this can prevent too many objects from occupying the screen, and the new object can be added appropriately while maintaining the balance of display. For example, when a new object 41 is added in response to operation performed with the operation unit 28 and a touch on a portable terminal, it may be possible to allow the operator to recognize the original position before the movement (for example, the position on the display unit 27 touched by the operator) by, e.g., displaying a new object 41, which is to be added, with a lighter toner or displaying the contour of the object. In this case, after the position is determined, the new object 41 returns back to the original display, and if it is necessary to move the object as described above, the object is displayed at the moved position. It may be possible to display a message on a screen to notify the operator that it is necessary to move an object and then display a new object at the moved position. In a case where a new object is to be added from the computer terminal 30 or the recording medium, it is not necessary to clearly notify the operator that the new object 41 is moved by the control explained above even in such case, and the result of the control explained above may be reflected on the display screen. These issues are also applicable to the second and third embodiments explained below.

### Second Embodiment

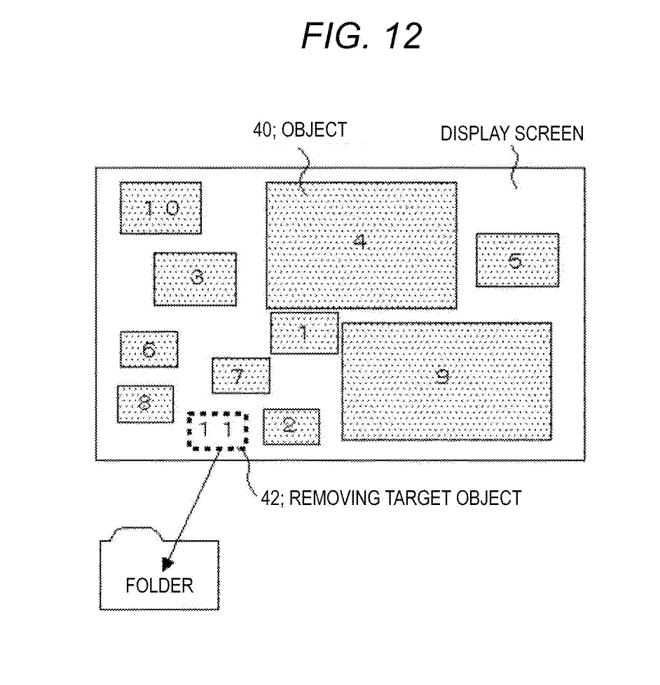

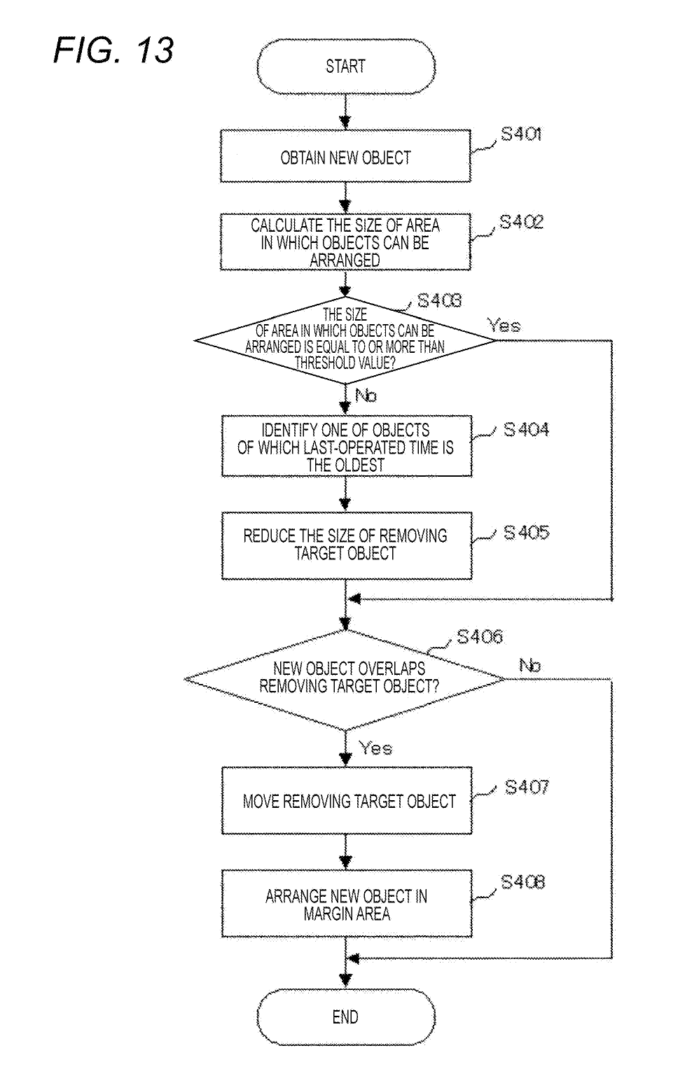

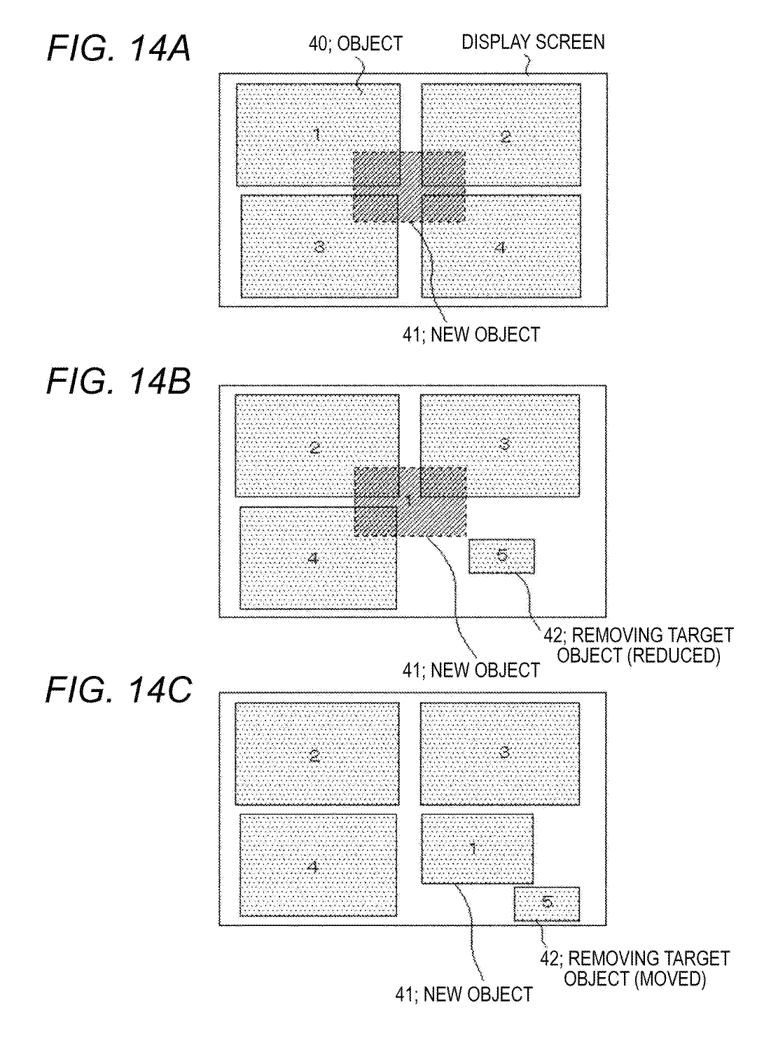

Subsequently, an object display system, an object display control program, and an object display control method according to the second embodiment of the present invention will be explained with reference to FIG. 13 and FIGS. 14A to 14C. FIG. 13 is a flowchart diagram illustrating processing of a display apparatus according to the present embodiment. FIG. 14 is a schematic diagram illustrating a display control of an object.

In the first embodiment explained above, when the size of area in which objects can be arranged is less than the predetermined value, the object of which last-operated time is the oldest is erased from the display screen, so that the size of area in which objects can be arranged is caused to be equal to or more than the predetermined value. In the present embodiment, the object is not erased from the display screen but the size thereof is reduced, so that the size of area in which objects can be arranged is caused to be equal to or more than the predetermined value. In this case, the configuration of a display apparatus 20 is the same as the first embodiment, but a control unit 21 (processing unit 21b) reduces the size of the removing target object, and as necessary, the control unit 21 (processing unit 21b) performs processing to move the removing target object on the display screen.

Hereinafter, the operation of the display apparatus 20 will be explained. A CPU 22 extracts a display control program stored in a ROM 23 or a storage unit 25 to a RAM 24 and executes the display control program, thus executing each processing as shown in the flowchart diagram of FIG. 13. In the explanation, multiple objects are considered to be displayed on a display screen of the display unit 27 in advance.

First, the control unit 21 uses the interface unit 26 to obtain data of the new object from the computer terminal 30 or the recording medium (S401). When the data of the new object are saved in the storage unit 25 of the display apparatus 20, the control unit 21 reads the data of the object from the storage unit 25, and allows the user to select a new object on the selection screen of the objects.

Then, the control unit 21 (area size determination unit 21a) refers to object information stored in the storage unit 25 (size information), and calculates the occupied size of area of all the objects displayed on the display unit 27 and calculates the size of area in which objects can be arranged that is obtained by subtracting the occupied size of area of the objects from the size of area of the display screen of the display unit 27 (S402), and determines whether the calculated size of area in which objects can be arranged is equal to or more than a threshold value (S403).

When the size of area in which objects can be arranged is determined to be equal to or more than the threshold value, S406 is subsequently performed, and when the size of area in which objects can be arranged is less than the threshold value, the control unit 21 (processing unit 21b) refers to object information (operation history information), and identifies one of objects of which last-operated time is the oldest from among the objects displayed on the display unit 27 (S404), and refers to the object information (size information) and reduces the size of the removing target object so that the size of area in which objects can be arranged becomes equal to or more than the threshold value (S405). When the size of area in which objects can be arranged does not become equal to or more than the threshold value by just reducing the size of the object of which last-operated time is the oldest, then the control unit 21 (processing unit 21b) may identify an object of which last-operated time is the second oldest in order and reduce the size of the object.

In this case, in the present embodiment, the removing target object is not erased but the size thereof is reduced, and therefore, the reduced removing target object may overlap the new object. Therefore, the control unit 21 (processing unit 21b) determines whether the new object overlaps the removing target object (S406), and when the new object overlaps the removing target object, then the removing target object is moved (S407), so that the overlap between the objects is solved. Thereafter, the control unit 21 (processing unit 21b) arranges the new object in an area where no object is displayed (margin area), and displays the new object on the display unit 27 (S408).

Even in the present embodiment, the new object is considered to be arranged without changing the size of the new object (without enlarging or reducing the size of the new object). The location where the new object is arranged is not limited, and, for example, when the operation unit 28 (a touch panel or a mouse) is used to designate the position, the new object may be arranged at that position (when it overlaps an object which is already displayed, the new object is displayed at such a shifted position that does not overlap the existing object), or when the position is not designated, the new object may be arranged at any given position that does not overlap an object which is already displayed (for example, in a central portion of the largest margin area), or the new object may be arranged in proximity to the same object attribute (text, graphics, and image).

The display control explained above will be explained with reference to a specific example. As shown in FIG. 14A, the objects 40 denoted with the numbers “1” to “4” are displayed on the display screen, and a new object 41 is added in a state where the size of area in which objects can be arranged is less than the threshold value. In this case, as shown in FIG. 14B, the last-operated time of the new object 41 is the latest, and therefore, the number thereof becomes “1”, and one is added to the numbers of the other objects 40, so that the numbers of the other objects 40 are updated to “2” to “5”. Then, the object of which last-operated time is the oldest (an object of which number is “5”) is identified as the removing target object 42, and the size of the removing target object 42 is reduced so that the size of area in which objects can be arranged becomes equal to or more than the threshold value.

In this state, the new object 41 is arranged so as not to overlap the other objects (the objects of which numbers are “2” to “4”), but when the new object 41 overlaps the removing target object 42, the removing target object 42 is moved to prevent the objects from overlapping each other as shown in FIG. 14C

As described above, in the present embodiment, when the size of area in which objects can be arranged is less than the threshold value when a new object is added, the size of the object of which last-operated time is the oldest (removing target object) is reduced, and therefore, the new object can be added appropriately while the balance of display is maintained. When the new object overlaps the removing target object of which size has been reduced, the removing target object is moved, and therefore, the reduction of the visibility caused by the overlapping of the objects can be prevented.

### Third Embodiment

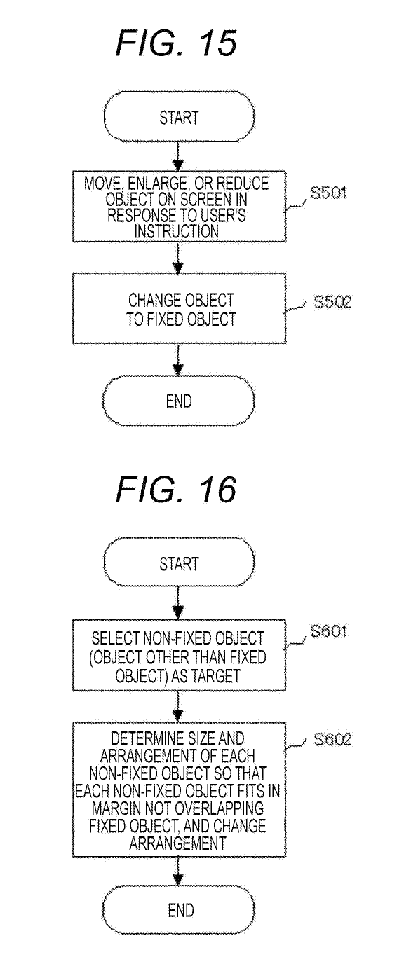

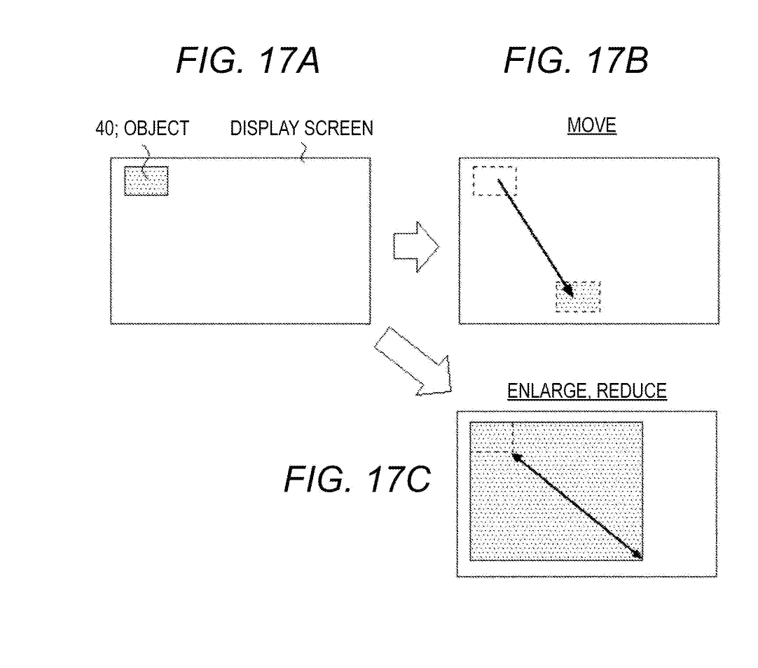

Subsequently, an object display system, an object display control program, and an object display control method according to the third embodiment of the present invention will be explained with reference to FIG. 15 to FIGS. 19A to 19C. FIGS. 15 and 16 are flowchart diagrams illustrating processing of a display apparatus according to the present embodiment. FIGS. 17A to 17C to FIGS. 19A to 19C are schematic diagrams illustrating display control of an object.

In the first embodiment explained above, the removing target object is removed from the display screen, and in the second embodiment, the size of the removing target object is reduced, and the removing target object is removed, but even if the removing target object is erased, reduced, and moved, the new object may overlap the other objects other than the removing target object in some cases. Therefore, in the present embodiment, when the new object overlaps the other objects, the arrangement of the other objects is changed, so that the overlapping of the objects is solved.

Hereinafter, operation of a display apparatus 20 will be explained. A CPU 22 extracts a display control program stored in a ROM 23 or a storage unit 25 to a RAM 24 and executes the display control program, thus executing each processing as shown in the flowchart diagram of FIGS. 15 and 16. In the explanation below, a fixed object means an object which is moved when it is identified as a removing target object or when it is manipulated by a user but is not moved when automatic arrangement processing is performed as shown in FIG. 16. On the other hand, a non-fixed object means an object which is other than the fixed object and which is moved when it is identified as a removing target object, when it is manipulated by a user, or when the automatic arrangement processing is performed.

As shown in FIG. 15, when the fixed object is set, the control unit 21 (processing unit 21b) monitors operation performed with objects displayed on the display unit 27. When the user performs operation such as moving of an object (see FIGS. 17A, 17B) and enlarging or reducing of an object (see FIGS. 17A, 17C) within a certain period of time (for example, 5 minutes) since the target object was last operated (S501), then the object is determined to be an important object to which the user pays attention, and the operated object is changed to the fixed object, and object information (object attribute) is set for the fixed object.

Thereafter, according to FIG. 6 or 7 of the first embodiment and FIG. 13 of the second embodiment, removing processing (erasing or reducing, moving) is performed on the removing target object, and when a new object is arranged in S206, S307, S408, the automatic arrangement processing of the object is performed.

More specifically, as shown in FIG. 16, the control unit 21 (processing unit 21b) refers to the object information (object attribute), and identifies an object which is set as the non-fixed object from among objects displayed on the display unit 27 (the objects other than the new object), and selects the object in question as the target of the automatic arrangement (S601). It should be noted that the new object is an important object to which the user pays attention, and therefore, the object information (object attribute) is set as the fixed object.

Then, the size and the position of each non-fixed object are determined so that the non-fixed objects (including the new object) fit in the margin area which is the area where the fixed object is displayed, and the arrangement of the non-fixed object is changed on the basis of the size and the position determined (S602).

In this case, if the manipulated object is still set as the fixed object, then, the number of fixed objects increases on every operation, and the layout of the objects cannot be changed appropriately in the automatic arrangement processing. Therefore, when the control unit 21 (processing unit 21b) performs the automatic arrangement processing to arrange the new object, all the fixed objects are preferably changed to non-fixed objects, and if the user operation is not performed on the object in question within a predetermined operation reception time (for example, before ten minutes passes since the moving arrangement processing) since the automatic arrangement processing, then it is preferable to change the fixed objects to the non-fixed objects.

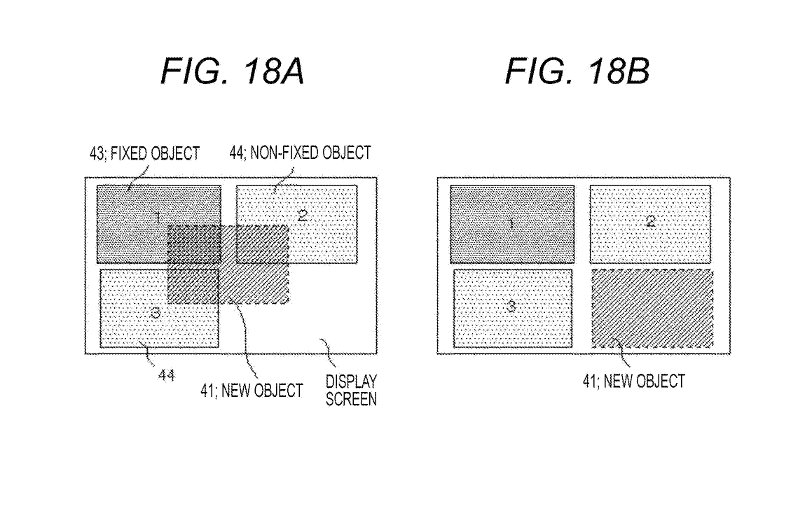

The display control explained above will be explained using a specific example. As shown in FIG. 18A, a fixed object 43 (object of which number is “1”) and non-fixed objects 44 (objects of which numbers are “2” and “3”) are arranged on the display screen. In this state, when a new object 41 is to be added so as to overlap these objects, and the size of area in which objects can be arranged is sufficiently large, the new object 41 is moved to the margin area not overlapping the fixed object 43 and the non-fixed object 44 as shown in FIG. 18B.

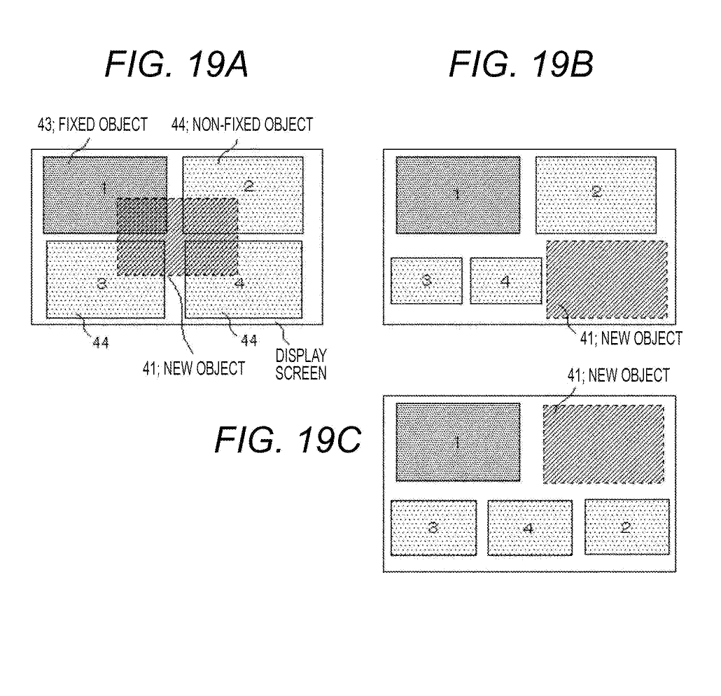

On the other hand, as shown in FIG. 19A, a fixed object 43 (object of which number is “1”) and non-fixed objects 44 (objects of which numbers are “2” to “4”) are arranged on the display screen. In this state, when a new object 41 is to be added so as to overlap these objects, the size of area in which objects can be arranged is small. In this object arrangement, a new object 41 cannot be added so as not to overlap other objects, and when the size and the arrangement of an important object are changed, it is impossible to have an effective discussion.

Therefore, in such case, the sizes and the arrangement of multiple non-fixed objects 44 are changed to make a margin area, and the new object 41 is moved to the margin area. For example, as shown in FIG. 19B, the sizes and the arrangement of two non-fixed objects 44 (for example, objects of which numbers are “3” and “4”) are changed to make a margin area at a predetermined position of the display screen (at the lower right in this case), and the new object 41 is moved to that margin area. As shown in FIG. 19C, the sizes and the arrangement of all the non-fixed objects 44 are changed to make a margin area at a predetermined position of the display screen (at the upper right in this case), and the new object 41 is moved to that margin area.

As described above, in the present embodiment, when the new object overlaps the objects other than the removing target object even if the removing target object is erased, reduced, or moved, the sizes and the positions of the non-fixed objects other than the important fixed object to which the user pays attention are automatically changed, and therefore, the layout can be changed appropriately. An object is set as a fixed object by just manipulating the object, and when operation is not performed within a predetermined time, it is set as a non-fixed object, and therefore, the user's operability can be improved, and multiple objects of which degrees of importance are changed in accordance with progress of the discussion can be displayed appropriately.

It should be noted that the present invention is not limited to the above embodiment, and the configuration and the control of the present invention can be changed as necessary as long as not deviating from the gist of the present invention.

For example, in the above embodiments, a single user performs operation. Alternatively, in a case where multiple users perform operation at a time, the control of the present invention can be applied to operation of each user.

The present invention is usable for a system capable of operating objects such as texts, graphics, and images, and more particularly, the present invention is usable for a system that can be operated by multiple operators in cooperation, a display control program operating on the system, a recording medium recording the display control program, and a display control method for an object on the system.

Although the present invention has been described and illustrated in detail, it is clearly understood that the same is by way of illustrated and example only and is not to be taken by way of limitation, the scope of the present invention being interpreted by terms of the appended claims.

What is claimed is:

1. An object display system comprising:
a display unit configured to display an object on a display screen;
an operation unit enabling the object to be operated; and
a control unit which controls the display unit and the operation unit,
wherein, when a new object is added, the control unit determines whether a display state of a plurality of objects satisfies a predetermined removing condition on the basis of a size of area of the plurality of objects displayed on the display screen, and
when the display state of the plurality of objects satisfies the removing condition, the control unit controls the display unit so as to remove at least one particular object selected from among the plurality of objects from at least a portion of the display position of the particular object.

2. The object display system according to claim 1, wherein the control unit derives a size of area in which objects can be arranged that is obtained by subtracting a size of area of the plurality of objects from a size of area of the display screen, and determines whether the size of area in which objects can be arranged is less than a predetermined threshold value, and when the size of area in which objects can be arranged is less than the threshold value, the control unit controls the display unit so as to remove the particular object from at least a portion of the display position of the particular object.

3. The object display system according to claim 1, wherein the control unit controls the display unit so as to erase the particular object from the display screen or reduce a size of the particular object.

4. The object display system according to claim 1, wherein the control unit sets, as the particular object, an object of which elapsed time since a last operation is the longest, on the basis of an operation history of the plurality of objects.

5. The object display system according to claim 1, wherein the control unit sets, as a fixed object, one of the plurality of objects that is operated with the operation unit within a certain period of time since a last operation, and changes an arrangement of non-fixed objects other than the fixed object and the new object.

6. The object display system according to claim 5, wherein the control unit arranges the non-fixed objects so that objects do not overlap each other.

7. The object display system according to claim 5, wherein when user operation is not performed on the fixed object within a predetermined operation reception time since the control unit removes the particular object from at least a portion of the display position, the control unit changes the fixed object to a non-fixed object.

8. A non-transitory recording medium recording a computer readable object display control program operating with a control unit which controls a display unit configured to display an object on a display screen and an operation unit enabling the object to be operated,
wherein the recording medium recording the object display control program causes the control unit to execute:
first processing in which, when a new object is added, a determination is made as to whether a display state of a plurality of objects satisfies a predetermined removing condition on the basis of a size of area of the plurality of objects displayed on the display screen; and
second processing in which, when the display state of the plurality of objects satisfies the removing condition, at least one particular object selected from among the plurality of objects is removed from at least a portion of the display position of the particular object.

9. The non-transitory recording medium recording a computer readable object display control program according to claim 8, wherein in the first processing, the size of area in which objects can be arranged is derived by subtracting the size of area of the plurality of objects from the size of area of the display screen, and a determination is made as to whether the size of area in which objects can be arranged is less than a predetermined threshold value, and
in the second processing, when the size of area in which objects can be arranged is less than the threshold value, the particular object is removed from at least a portion of the display position of the particular object.

10. The non-transitory recording medium recording a computer readable object display control program according to claim 8, wherein in the second processing, the particular object is erased from the display screen, or a size of the particular object is reduced.

11. The non-transitory recording medium recording a computer readable object display control program according to claim 8, wherein in the second processing, an object of which elapsed time since a last operation is the longest is set as the particular object on the basis of an operation history of the plurality of objects.

12. The non-transitory recording medium recording a computer readable object display control program according to claim 8, wherein in the second processing, one of the plurality of objects that is operated with the operation unit within a certain period of time since a last operation is set as a fixed object, and an arrangement of non-fixed objects other than the fixed object and the new object is changed.

13. The non-transitory recording medium recording a computer readable object display control program according to claim 12, wherein in the second processing, the non-fixed objects are arranged so that objects do not overlap each other.

14. The non-transitory recording medium recording a computer readable object display control program according to claim 12, wherein when user operation is not performed on the fixed object within a predetermined operation reception time since the particular object is removed from at least a portion of the display position, the fixed object is changed to a non-fixed object.

15. An object display control method for a system including a display unit configured to display an object on a display screen, an operation unit enabling the object to be operated, and a control unit which controls the display unit and the operation unit,
wherein the object display control method causes the control unit to execute:
first processing in which, when a new object is added, a determination is made as to whether a display state of a plurality of objects satisfies a predetermined removing condition on the basis of a size of area of the plurality of objects displayed on the display screen; and
second processing in which, when the display state of the plurality of objects satisfies the removing condition, at least one particular object selected from among the plurality of objects is removed from at least a portion of the display position of the particular object.

16. The display control method according to claim 15, wherein in the first processing, the size of area in which objects can be arranged is derived by subtracting the size of area of the plurality of objects from the size of area of the display screen, and a determination is made as to whether the size of area in which objects can be arranged is less than a predetermined threshold value, and
in the second processing, when the size of area in which objects can be arranged is less than the threshold value, the particular object is removed from at least a portion of the display position of the particular object.

17. The display control method according to claim 15, wherein in the second processing, the particular object is erased from the display screen, or a size of the particular object is reduced.

18. The display control method according to claim 15, wherein in the second processing, an object of which elapsed time since a last operation is the longest is set as the particular object on the basis of an operation history of the plurality of objects.

19. The display control method according to claim 15, wherein in the second processing, one of the plurality of objects that is operated with the operation unit within a certain period of time since a last operation is set as a fixed object, and an arrangement of non-fixed objects other than the fixed object and the new object is changed.

20. The display control method according to claim 19, wherein in the second processing, the non-fixed objects are arranged so that objects do not overlap each other.

21. The display control method according to claim 19, wherein when user operation is not performed on the fixed object within a predetermined operation reception time since the particular object is removed from at least a portion of the display position, the fixed object is changed to a non-fixed object.
